(19) United States
(12) Patent Application Publication
(10) Pub. No.: US 2014/0101122 A1
(43) Pub. Date: Apr. 10, 2014

(54) System and method for collaborative structuring of portions of entities over computer network

(71) Applicant: Nir Oren, Hod Hasharon (IL)

(72) Inventor: Nir Oren, Hod Hasharon (IL)

(21) Appl. No.: 13/648,318

(22) Filed: Oct. 10, 2012

(51) Int. Cl. G06F 17/30

(52) U.S. Cl. CPC G06F 17/30961
USPC 707/706; 707/738

(57) ABSTRACT

Techniques for arranging information in a computer based network system. The techniques running by processors, enabling the hierarchical arrangement of tree nodes by users, the ability to upload documents to the system, the ability to mark portion(s) of document(s) and associate each portion with at least one tree node, later saved on data storage devices.

### CROSS-REFERENCE TO RELATED APPLICATIONS

### US Patent Documents

This application claims priority to U.S. Provisional Patent Application No. 61/550,395, entitled “System and method for collaborative structuring of portions of entities over computer network” and filed on Oct. 22, 2011, which is incorporated herein by reference

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention relates to the field of arranging and retrieving information in a computer-based network system.

More particularly, the present invention is in the field of collaborative structuring of portions of entities over computer network.

### BACKGROUND OF THE INVENTION

Anyone who has searched for information on the World Wide Web using search sites, such as Google or Yahoo!, is familiar with the process of searching for information in at least one of two ways: by providing a textual query to the search engine describing the information sought (e.g., “Siamese cats”), and by browsing through a hierarchical list of categories provided by the site. For example, in the latter case one might select the category “Animals,” followed by “Mammals,” “Felines,” and “Domestic Cats” to arrive at a list of documents about Siamese cats available on the World Wide Web.

Information retrieval systems, generally called search engines, are now an essential tool for finding information in large scale, diverse, and growing corpuses such as the Internet. Generally, search engines create an index that relates documents (or “pages”) to the individual words present in each document. A document is retrieved in response to a query containing a number of query terms, typically based on having some number of query terms present in the document. The retrieved documents are then ranked according to other statistical measures, such as frequency of occurrence of the query terms, host domain, link analysis, and the like. The retrieved documents are then presented to the user, typically in their ranked order, and without any further grouping or imposed hierarchy. In some cases, a selected portion of a text of a document is presented to provide the user with a glimpse of the document's content. (US 2008/7426507 B1)

Direct “boolean” matching of query terms has well known limitations, and in particular does not identify documents that do not have the query terms, but have related words. For example, in a typical Boolean system, a search on “Australian Shepherds” would not return documents about other herding dogs such as Border Collies that do not have the exact query terms. Rather, such a system is likely to also retrieve and highly rank documents that are about Australia (and have nothing to do with dogs), and documents about “shepherds” generally. (US 2008/7426507 B1)

This kind of challenge is better addressed using Taxonomy. The hierarchical list of categories provided by a search site is one example of taxonomy. More generally, taxonomy is a tree structure of hierarchically ordered categories used to classify objects and/or data. Taxonomies are often used to aid and facilitate the systematic retrieval of relevant information out of large amounts of stored data, as the example of the Internet search engine demonstrates.

For taxonomy to be useful for these purposes, the data must first be classified according to taxonomy by associating each datum (e.g., document) with one or more nodes in the taxonomy. For example, documents that relate to Siamese cats must be tagged in some way as being associated with the “Domestic Cats” node in the taxonomy if the taxonomy-browsing technique described above is to successfully retrieve web pages relating to Siamese cats.

Classifying data according to taxonomy is a difficult problem, particularly if a large amount of data must be classified. Even classifying a single document may be tedious, time-consuming and error prone due to the need to: (1) analyze the content of the document, (2) identify any relationships between the document content and the classes defined by nodes in the taxonomy, and (3) identify one or more such nodes with which to associate the document.

There also exist a concept called ‘tags’. In computer systems terminology, a tag is a non-hierarchical keyword or term assigned to a piece of information (such as an Internet bookmark, digital image, or computer file). This kind of metadata helps describe an item and allows it to be found again by browsing or searching. However, tags (sometimes referred to as ‘folksonomy’) do not have a hierarchy, and as such, they are context-less.

There have been attempts in prior arts (e.g. US 2011/0137186 A1, US 2009/287674 A1, US 2010/0274733 A1) to build or to enrich a taxonomy in an automated fashion, according to analysis of tags, document text or other algorithms, however, none of these attempts qualifies as a high-quality, useful and intuitive taxonomy to be used by humans.

Yet another disadvantage with systems in the prior arts, is that they associate whole entities (i.e. documents, photos, audio files) with Tags; forcing the user to view, browse, manually search, read or listen to the entity as a whole, in order to find the information of interest. This could lead to a great loss of time, since the entity can be very long and complex—such as a large e-book or long piece of audio recording—while the information the user interested in could reside in only a small portion of the entity.

It is realized in recent years that community-based information arrangement platforms yields high quality organized information, such as in Wikipedia, StackOverflow and other sites which encourage users to contribute to the system. The quality of the information is ensured via the means of moderation and a voting-system. However, these sites are designed that users edit and/or create new content (“wiki”) within the site itself; uploading document to these sites is merely meant to have it downloadable as an attachment; the system is not designed to parse, process or display the uploaded files in a way which gives further categorization or voting on them. Another disadvantage with these sites is that they do not encourage the users to arrange the information in taxonomy.

There are also web sites such as scribd.com, docstoc.com that encourages their users to upload document files which are later processed by the system to be viewable. However in these sites, the categorization ability is minimalistic, and the main concern of these site is merely with storing the documents and making them viewable online.

In other art, such as in US 2011/7930279 B2, there is a description of a system meant to encourage its users to arrange “web forum posts” in an hierarchical fashion, and to allow user voting; however, in the context of making information, and more specifically, documents, better accessible, this system have number of disadvantages, for example—(a) users cannot associate a narrowed, specific part of a document to a taxonomy node, and therefore, extraction of information requires looking at objects as a whole. (b) users do not have the ability to view history of actions and to undo one or more actions, which may cause difficulties in the elimination of spam, and general degradation of information (c) users do not have the ability to vote on such history actions (d) full system description is not enclosed (e) and more.

It is realized that in the prior arts, there are systems, which allow users to create a tree structure in a collaborative fashion and associate files to it: one example is having a shared directory in the Microsoft Windows product, where various users are connected to a “file share”, and can delete, rename or add a tree node (“directory” in this semantics); a shared directory managed by multiple users in Source Control products such as MS SourceSafe™, Apache Subversion, and so on; what is missing is a method which allows distinguishing useful and relevant information that is properly categorized, encourage users to contribute and has a low percentage of spam.

### PRIOR ART PATENTS

US 2011/0173186 A1
US 2009/0287674 A1
US 2011/7930279 B2
US 2010/0274733 A1
US 2011/7516397 B2
US 2008/7426507 B1
US 2009/287674 A1
U.S. Pat. No. 7,761,436 B2
US 2010/332478 A1
US 2008/016091 A1
US 2007/033092 A1
U.S. Pat. No. 5,924,072
US 2009/292686
WO 2007/062293 A2

### SUMMARY OF THE INVENTION

One aspect of the invention is a method for arranging information in a computer based network system. The method comprises enabling the hierarchical arrangement of tree nodes by users, the ability to upload documents to the system, the ability to mark portion(s) of document(s) and associate each portion with at least one tree node.

Another aspect of the invention is a system for arranging information in a computer based network system. The system comprises one or more processor(s), a software module enabling the hierarchical arrangement of tree nodes, a software module enabling uploading of documents to the system, a software module enabling marking of one or more portions of the document and a software module enabling associating each portion with at least one tree node.

Yet another aspect of the invention is a computer program product embodied in a computer usable memory. The computer program product includes one or more tools to manage hierarchical arrangement of tree nodes, computer readable program codes are coupled to the computer usable memory that allow the uploading of a document to the system and marking by user(s) of one or more portions of documents, associating each portion with at least one tree node.

The system and method allow association of different portions of entities to different tags or nodes. For example, it is possible that in 300-page document on medical research, some paragraphs are related to hospitals, some to research methodology, some to diseases and so on; in which case each paragraph may be associated by users (if they choose to) to its corresponding taxonomy node.

The system and method are designed to encourage users to build and update the tree, such that it will grow to become highly-intuitive, relevant and comprehensive taxonomy tree, which expresses an arrangement of categories and sub-categories in a way that is useful for navigation and finding information that is associated with it. Many people believe that this is not feasible (i.e. citation “The human effort required for classifying material and maintaining the directories up-to-date cannot keep pace with the exponential growth of the Web. Therefore, automatic categorization of Web-based information resources into these directories is required.”—Joshi et al. US 2009/7,516,397)

In different embodiments, the system may include a user login system, whether internally managed or by external service(s) such as Google Accounts, Facebook API, Open ID, Microsoft™ Active Directory, and so on, which allows identification of the user; in other embodiments, login is not required.

In different embodiments, Users are able to view all tags (and meta-data related to them, such as the marked text) associated with a node. This ability, may allow users to easily and rapidly view relevant information from documents, without the need to read or search each document.

In different embodiments, users are able to navigate from a view where one or more tags and their corresponding meta-data is shown, to a view where the corresponding document(s) is (are) displayed, possibly focusing and/or highlighting the marked area. This ability, may allow users to easily locate relevant information in documents, without the need to read or search the entire document.

In different embodiments, marking a portion of a document is done using the mouse, such as when marking part of a Microsoft Word™ document and/or using SHIFT-UP/DOWN keys.

In different embodiments, tagging is done by drag-n-drop the marked portion from the document to a node in the tree. In a different embodiment, tagging is done by using CTRL-C to “copy” the marked region into the clipboard, and CTRL-V to “paste” the marked region into the tree node.

In different embodiments, the system allows the tagging of any resource, not just documents. In order to mark portion(s) of a resource, there have to be a marking method relevant to the medium and is common in the art—for example, in order to mark portions of a photo, one can use methods that are known from the Adobe Photoshop™ software, such as magic wand, rectangle selection etc; and to mark a portion of an audio file, one would use marking methods that is common in software such as Sound Forge™, Cool Edit™ etc.

In different embodiments, viewing and marking of entities (such as documents) which were uploaded to the system is done from an external program and/or external service and/or plug-in and/or a web service, such as Microsoft Word™, Windows Media Player, Adobe Photoshop™, CoolEdit™ etc. this means that converting entities to a unified format (FIG. 3 element 30) is not necessary in this embodiment.

In different embodiments, the system allows various combinations of methods to receive entities (such as documents) into the system: upload by users, bulk upload by system administrator, scrapping from other websites, ‘pushing’ by other website.

It is realized that in previous arts there have been systems in which it was possible to give different permissions to different users on tree nodes; and there have also been systems where users had been given permission according to their contribution and evaluation made by peers. However, none of these are useful to reflect what is needed to establish an ideal environment meant to create a reliable tree in a collaborative fashion. For example, in traditional OS such as Windows™ and Linux™ it is possible to set a permissions on a directory, but not in a way that the user gains further permission if other users ‘like’ his actions.

In different embodiments, the permission is determined by user's access score on a node, and not by authority score.

In different embodiments, votes on actions which took place more recently, have a greater effect on authority and/or permission, compared to votes on actions which took place more in the past.

In different embodiments, in order to encourage users to contribute to low-activity nodes, there is a distinction between nodes that cross a certain prestige level and those who don't; nodes that have low prestige require less authority/access for users to execute actions upon them.

In different embodiments, in order to encourage users to contribute and to establish a competition between them, it is possible to see a list of top contributors for node(s) using a tooltip, menu option, periodic report, push notification or other means.

In different embodiments, in order to encourage users to contribute to the system, more permission is given to users who contributed to the system recently, therefore, recent actions and/or votes have greater effect on authority than old ones.

In different embodiments, to determine user's permission on a node, we take into account the accumulated authority of the node and its sub-nodes, giving less and less weight to sub-nodes in a deeper level.

In different embodiments, there is an ability to associate tree node, or a tag, with a geographical location, so that it is possible to conduct location based searches.

In different embodiments, there are different values assigned to ‘voting score mapping’ (FIG. 11) and/or required authority (FIG. 10)

In different embodiments, the permission to perform actions on certain nodes, such as nodes close to the root, is determined by system administrator, and not by authority system.

In different embodiments, the system scans the interne to search additional copies of a document and when such copy is found, it notifies the relevant users—for example the one who uploads the document, user who were involved in creating tags on the document, and so on.

In different embodiments, the users can declare that they hold the copyright to certain documents or entities, and apply restrictions upon them (such that only part of the entity is viewable to non-paying users, and to view the whole text a payment is required)

In different embodiments, incomes from payment and/or advertisement are distributed between the copyright owner, those who did the tagging which led to the purchase of the document, and the website owners.

In different embodiments, there are context-sensitive advertisements.

In different embodiments, the system manages different versions of taxonomy, and users can select the versions they like the most, or that the system recommend to them.

In different embodiments, the system supports ‘linking nodes’—that is, existing nodes can be also associated as children of other nodes (usually because in the eyes of the users they fit to numerous concept), i.e. ‘Labs’ can be situated under both ‘Education->Schools->Facilities’ and ‘Education->Science’. In the case of linking, there is a GUI indication that the node appears in numerous nodes (such as a distinct color)

In different embodiments, the system gives full free document access only to the top percent of contributors, with the agreement of copyright holders hoping to be promoted by that.

In different embodiments, the users may choose to view a “history log” for specific node(s) only, or to a specific node and his children recursively.

In different embodiments, the users may vote on action(s) appearing in history log. Thus, it would be possible to evaluate actions whose effect is no longer visible on the tree, such as node deletion.

In paragraph [0115] it is noted that the Undo action works only where applicable; however in a different embodiment the Undo flow carries out newer actions from the undo log, until the point that the history action which the user wishes to undo is applicable again.

In different embodiments, in order to encourage users to contribute to the system, users are less exposed to advertisements, based on their contribution to the system, and/or authority, and/or access.

In different embodiments, users who upload documents may choose that other users have to pay in order to gain permission to download and/or view the full document text (“a limited document”)

In different embodiments, users are able to upload multiple files at once (bulk upload).

In different embodiments, in order to encourage users to contribute to the system, users are given permission to view limited documents, based on their contribution to the system, and/or authority, and/or access.

In different embodiments, the system described in this document is implemented as a web site. In other examples, it is implemented as java, winform, facebook, IPhone app, Android app or any development platform.

In different embodiments, it would be possible to conduct a search on the tree, using a search box situated just above the tree GUI. Typing a text in that box and pressing ‘enter’ leads to highlighting all the nodes containing the text.

In different embodiments, after a user has uploaded a document into the system, the system automatically searches the document for email addresses (by searching for the *@*.* pattern) and sends an email to the author, suggesting them to join as users to the system.

In different embodiments, the system scans the internet periodically to see if there are copyright infringements on documents or entities that users has uploaded, and report those infringements to copyright owners.

In different embodiments, the system notifies users about changes that occurred on nodes that interest the user the most (nodes in which they viewed tags, documents the most, or committed actions upon)

In different embodiments, users can choose to display in the tags list (FIG. 8 element 90) simultaneously the tags of multiple nodes.

In different embodiments, users can choose to include in the tags list (FIG. 8 element 90) the children of the node (i.e. recursive) the advantage from user's perspective is that normally in taxonomy, children of a node are related conceptually to the parent.

In different embodiments, the entities (such as documents) uploaded to the system are also saved in their original format (such as DOC, PDF, MP3, MKV etc.), allowing users to later download them.

In different embodiments, the tagging of portions of documents (and the tagging of portions of other entities) is used not only in relation to taxonomy but also in flat-hierarchy systems.

In different embodiments, the tagging of portions of documents (and the tagging of portions of other entities) is used not only in relation to community-based system, but also in traditional systems.

In different embodiments, the GUI is arranged and managed differently, since there are many GUI ways to fulfill the same fundamental function. Some examples: history, taxonomy, tags, document view, extended info, can be shown as popup windows, panes, tooltips, etc. they may take the screen space of former view or can be opened side-by-side alongside other view.

In different embodiments, users are able to report on an offensive content, or copyright infringement.

### GLOSSARY AND DEFINITIONS

“tag” (noun)—In the context of this system, is an association of a portion of a document, to a taxonomy node. In the context of prior arts, it could mean association between a label and an object (such as a document).

“tagging”, “tag” (verb)—the act (action) of creating a tag

“node”/“tree node”/“taxonomy node”/“container node”/“branch”/“tree branch”—represents data element of a tree structure. A node may have zero or more children, and zero or one parent. A node may have tags associated with it, and meta-data associated with it, such as name, id, etc. in the context of a GUI action it may also refer to the visual representation of the node such as a node in a Tree Control GUI.

“action class”—a type of operation that may occur in the system. for example: tagging a document, deleting a node, voting etc. are all action classes that may have an effect on the authority of users related to the operation.

“action”—an operation that happens in the system. For example, if a user has delete a node then an action of class “delete node” has occurred.

“Vote”—an evaluation made by a user regarding another's user action, such as vote up/vote down.

“Score”—a sum of votes.

“Voting score mapping”—a data structure or a configuration file, which maps action classes in the system to its corresponding numerical effect on the authority of one or more users related to the action. For example: Voting Down on a tag, may give +5 points to the user who performed the Voting action, and −10 (a negative value) to the person who originally created the tag.

“Local Authority”/“Local Authority level”/“Local Authority score”—a number representing the sum of all votes after being mapped by voting score mapping, in relation to one node and one user, without taking into consideration the node's children.

“Decay factor”/“Decrease factor”—a number representing a number which serves as multiplier to decrease an authority passing from a node to parent node

“Authority”/“Authority level”/“Authority score”/“User authority”—a number representing the sum of all votes after being mapped by voting score mapping, in relation to a parent node and one user, adding all children nodes in a recursive manner taking into account decay factor.

“Prestige”/“Prestige level”/“Node prestige”/“Branch prestige”—a number representing the sum of all authority scores of all users in relation to a node.

“bot”—a software process that is doing some kind of action or operation in the system, that is also being regularly done by humans.

“user”—in any place where mentioned a user, it serves as the traditional definition of “user” in computer systems, taking into account that a user can also be a “bot”.

“access”/“user access”/“access level”/“access score”—Similar to authority but is differential among users, that is, if one user has more authority it affects negatively the access of other users. Expressed as a percentile between 0 and 100.

“permission”/“user permission”/“permission level”—the ability of a user to perform an action in the system.

“limited document”—a document which some users have to pay in order to see in full

“history”/“action history”/“history log”—a data structure meant to store a log of actions took place in the system in a way that the actions are later reversible

“Upload”—Is the act of having the system processing a new document to be available in the system. One example is via HTTP POST which sends the file. Another example is via having the user specifying a URL of another site and having the system taking from a file from there. Another is via automated crawling which collects documents into the system. Another is via direct access to local file system.

“Marking”—The act of selecting a part of a greater entity. For example, pressing SHIFT-UP/SHIFT-DOWN is a way of marking text in Microsoft Word™

“Document name”—Unless otherwise noted, this refers to the original file name of the document, recognized upon entering the system.

### BRIEF DESCRIPTION OF THE DRAWINGS

FIG. 1 is a top view of the network topology of the present system of the invention;

FIG. 2 is a process flow diagram that illustrates a method for managing the main screen in accordance with the present invention;

FIG. 3 is a process flow diagram that illustrates a method for processing a document in accordance with the present invention;

FIG. 4 is a process flow diagram that illustrates a method for opening and allowing actions on a document in accordance with the present invention;

FIG. 5 is a process flow diagram that illustrates a method for showing and managing tags in accordance with the present invention;

FIG. 6 is a process flow diagram that illustrates a method for showing and managing history in accordance with the present invention;

FIG. 7 is a GUI example of the screen layout and illustration of how to enable the user to drag a marked portion of a document and drop it into a node;

FIG. 8 is a process flow diagram that illustrates a method for managing the taxonomy tree in accordance with the present invention;

FIG. 9 is an illustration of a data: a tree with nodes, voting data, decay factor parameter.

FIG. 10 is an illustration of a data: required authority for action classes FIG. 11 is an illustration of a data: voting score mapping

### DETAILED DESCRIPTION OF THE INVENTION

The following detailed description of the invention refers to the accompanying drawing and to certain preferred embodiments, but the detailed description does not limit the invention, which could be implemented in several ways.

As illustrated in the discussion below, the present embodiments include a system and method for providing users with a collaborative environment, in which it would be easy to retrieve paragraphs in documents which are of interest to users; in which it would be easy, rewarding and controlled to add new documents and to allow oneself and other users to categorize and tag them.

The present embodiments avoid the disadvantage of prior arts by combining altogether a modifiable taxonomy, a document uploading function, a document marking (text selection) function, a function to associate marked-text(s) with taxonomy node(s), a history log and a voting system tailored to the goal. Thus, knowledge in documents, which was previously inaccessible just because it required users to read whole documents or to guess keywords successfully will now be made accessible in the light of the present embodiments.

The present embodiments further avoids the disadvantage of prior arts by allowing making use of ‘collective wisdom’ without requiring that the ‘collective’ enter and revise full texts, which requires much time, effort and skill, as in Wikipedia or Stack Overflow web sites.

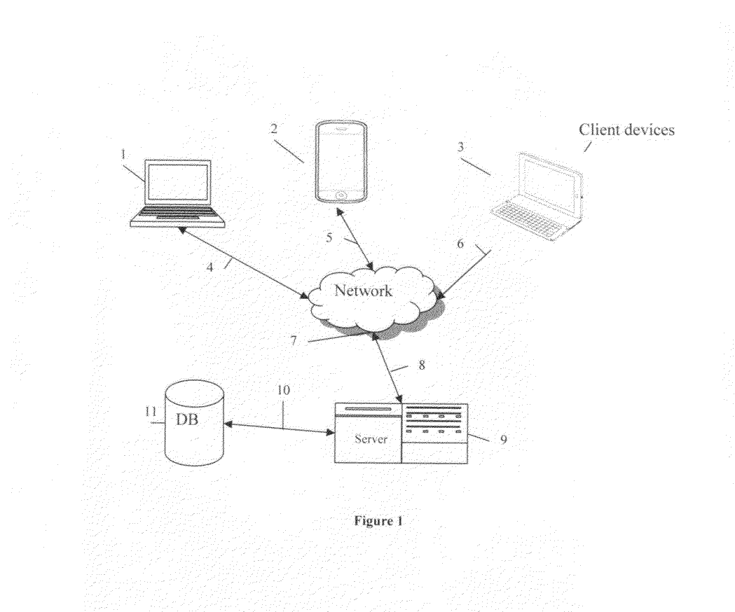

Referring now to the embodiments in more detail, in FIG. 1 there is shown a network topology of the system. In more details, there are several client devices 1,2,3 which interacts with a server 9 by the means of a network 4,5,6,7,8,10 which serves as a mediation. Network can be selected from a broad list, since the system and method are adequate to work with many networks. Some examples may be: TCP/IP (v4 or v6); UDP; SCTP; VTP; MTP/IP; File sharing such as SMB any general-purpose network infrastructures that have similar functions to those listed here, or a combination of such network infrastructures.

Still referring to FIG. 1 and the client devices 1,2,3: they comprise a CPU, Memory, OS such as Windows, Linux, iOS, Mac OS, Mac OS/X, Android, Symbian or the likes. Also, any other computer that can run a modern web browser is applicable.

Still referring to FIG. 1 and the client devices 1,2,3: the illustration of three client devices is for simplicity only; there could be more devices.

Still referring to FIG. 1 and the client devices, there is client-side software running in accordance with the preset invention. This software can be implemented over many modern software infrastructures, one of which can be a web-browser, utilizing JavaScript. Other suitable infrastructures include web-browser, utilizing Java applet; web-browser, utilizing Adobe Flash™; web-browser, utilizing Microsoft Silverlight™; Microsoft .NET application; iOS application; Android application; Java or C or C++ application; any general-purpose software infrastructures that have similar functions to those listed here, or a combination of such software infrastructures.

Still referring to FIG. 1, there is shown a Server 9. It comprises a CPU, Memory, OS such as Linux, Unix, Windows, Mac OS or the likes. Also, any other OS that is suitable to act as a modern computer server OS is applicable.

Still referring to FIG. 1 and the Server 9. The server comprises a server software infrastructure. The selected server software infrastructure can be selected from various options exist in the market. Some examples are: Apache+PHP; Apache+Ruby; IIS₊ASP; Apache Tomcat+JSP; C, Java or C++ or C# Application, or the likes.

Still referring to FIG. 1 and the Server 9, the diagram illustrates a single server, for clarity reasons only. In practice, the implementation supports a scenario where multiple servers are deployed, to allow better performance. This is a common practice in the art, and can be done for example using DNS Load Balancing.

Referring again to the server 9 in FIG. 1, it acts as a central location to which client computers connect with requests for information storing and retrieval. However, the connectors are drawn bi-directional, since data generally passes in both directions.

Still referring to FIG. 1, there is shown a DB 11 (Database). This refers to software running on a computer and which stores and retrieves data efficiently. Examples of such software including MySQL, Oracle, SQL SERVER, PostgreSQL, IBM DB2 and the likes. The DB may be installed on the same machine(s) as the server 9, or on separate machine. The diagram illustrates a single DB, for clarity reasons only. In practice, the implementation supports a scenario where multiple DBs are deployed.

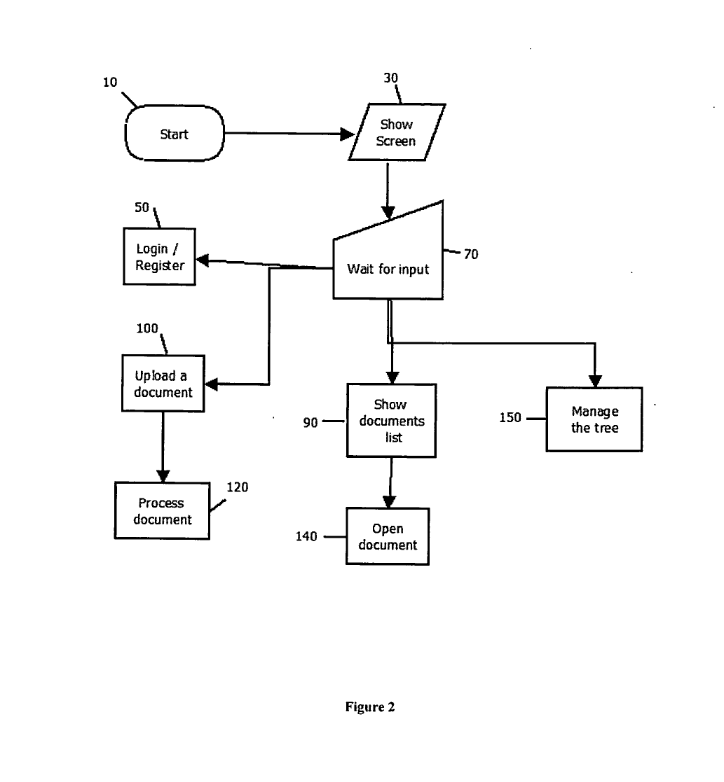

Referring now to FIG. 2, a high level functional diagram of the process flows and functions in a preferred embodiment of the present invention is shown.

Still referring to FIG. 2, the discussion on process flow starting from ‘start’ 10, after which it proceeds to ‘show screen’ 30 and allows the user to perform their selection as the system does ‘wait for input’ 70, common in GUI systems. The user may: ‘Login/Register’ 50, ‘Upload a document’ 100, ‘Show documents list’ 90, or ‘manage the tree’ 150.

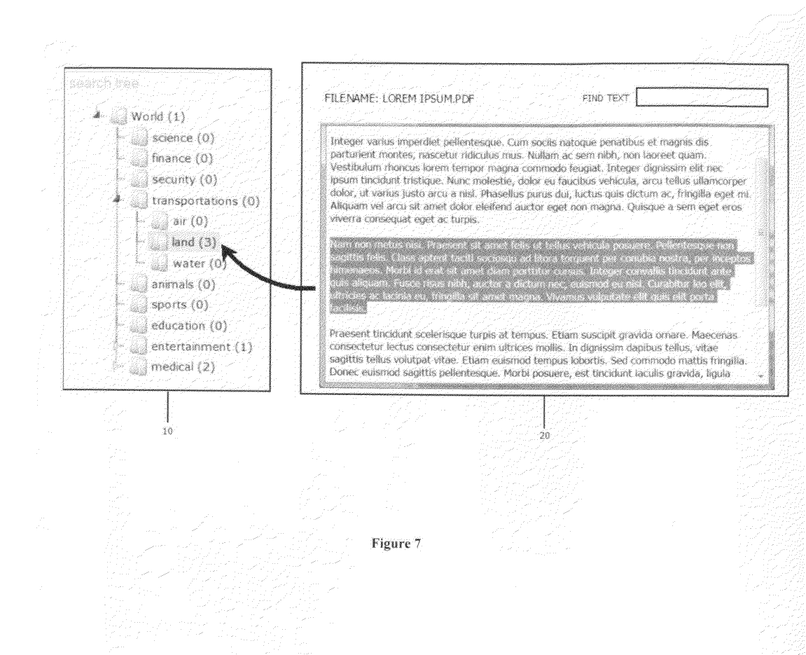

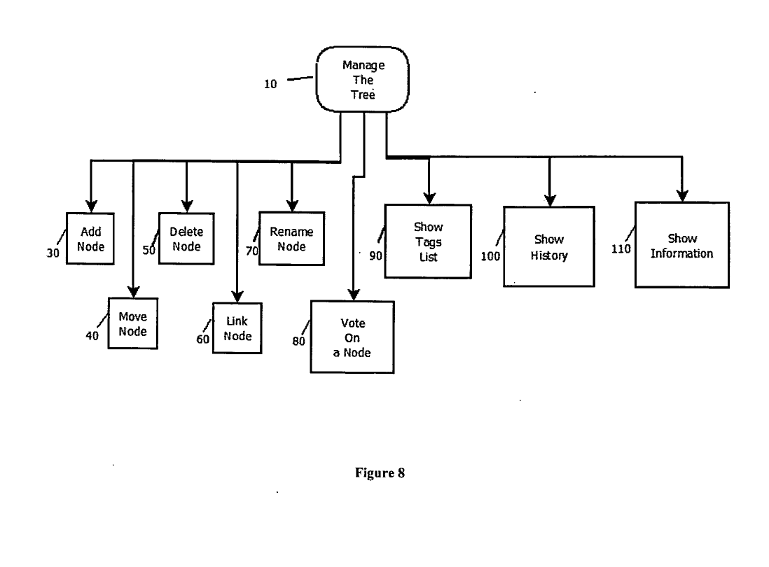

Still referring to FIG. 2 with more details: ‘Show Screen’ 30 shows a GUI comprises a tree whose data is retrieved from the server; a login/register option; a list of documents; an option to upload a document. The storing and retrieving of a tree is a common practice, however one difference is that each node's name is concatenated with a number indicating the number of tags associated with the node, wrapped by parenthesis (illustrated in FIG. 7 element 10)

Still referring to FIG. 2, ‘Upload a document’ 100 allows users to send a document from the client to the server using HTTP Post or by specifying a URL of a document located elsewhere on the net. The document can be in various formats such as PDF, DOC, DOCX, TXT, HTML, XML, RTF and the likes. After the user has uploaded the file the system proceeds to ‘Process document’ 120 which is later described in details.

Still referring to FIG. 2, ‘Show documents list’ 90 refers to a function which retrieves a list of documents exist on server which were uploaded previously by all the users. Since the list might be large, the list is delivered from server in chunks, i.e. 50 entries at a time with a paging option [i.e. “Prev” 1, 2, 3 . . . 20 “Next”]

Still referring to FIG. 2, ‘Show documents list’ 90, to ease the users in finding existing documents in the system, there are additional functions to allow filtering and free-text searching: Search document title; Search document text; Filter by date; Filter by username; Filter by number of tags; Filter by file format; Filter by filesize.

Referring again to FIG. 2, after the user has been presented with a list of documents (‘show documents list’ 90), he or she can choose that they would like to ‘open document’ 140 from the list, which is later described in details.

Still referring to FIG. 2, the user can choose to ‘manage the tree’ 150, referring to the tree which was drawn in ‘show tree’ 30. The implementation does not require that the users explicitly select to ‘manage the tree’—it is implicit by accessing nodes' context-menu, click on nodes, hovering over a node. More on this function is later described in details.

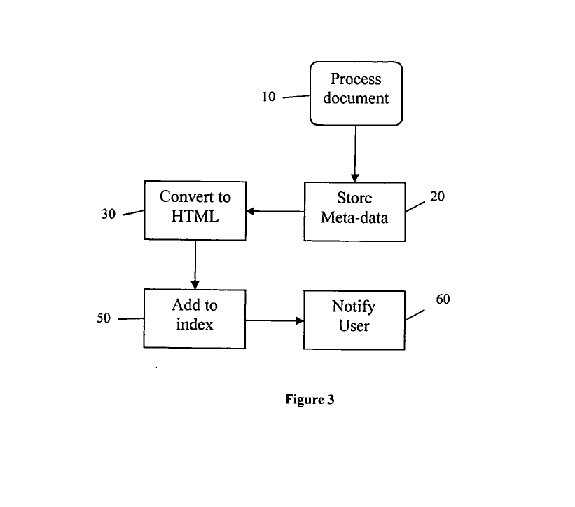

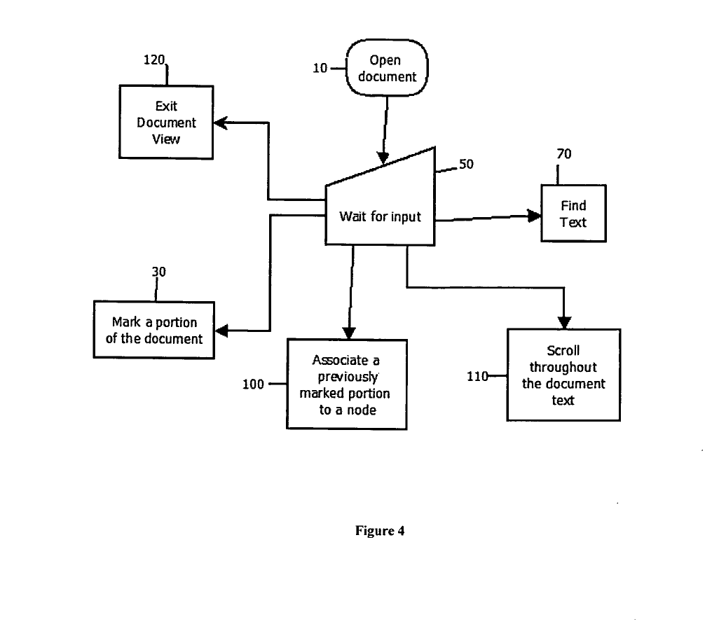

Referring now to FIG. 3, with regards to ‘Process document’ 10, (which has initiated after the user has uploaded a document to the system) the document is processed in a background process—the user can continue working with the system.

Still referring now to FIG. 3, the flow proceeds to ‘store meta-data’ 20; the server stores to the database information about the document such as Original file, Original Filename, Original file size, upload date and time, original URL (where applicable), Username, and assigns primary status—‘in processing’.

Still referring now to FIG. 3, the processing continues with calling ‘convert to HTML’ 30 function, to store the document in a unified HTML format. There exist in the market numerous tools which do it; a simple search in a search engine of ‘pdf to html’, ‘doc to html’, ‘rtf to html’ etc. yields sufficient number of options such as: Convert Doc™ by Soft Interface, Inc; PDFTOHTML by Derek Noonburg; PDF to HTML Online by BCL Research; DOC to HTML by Subsystems, Inc; Doc To HTML by Opilion Software; Total doc convertor by CoolUtils Development.

Still referring now to FIG. 3, with regards to ‘convert to HTML’ 30 function, if the input file is already in HTML format, executing a conversion tool is not required, but the javascript code should be removed using a server-side DOM processing library such as PHPQUERY.

Still referring to FIG. 3, after conversion, the document is being indexed (‘add to index’ 50) by a infrastructure such as Lucene/SOLR, Sphinx or the likes. If the conversion to HTML and adding to index terminated without severe errors, the system assign status—‘ready’ and the document becomes available to users.

Still referring to FIG. 3, the flow continues to ‘notify user’ 60, and the user is notified about the result of the operation (using a ‘push’ technology like email, ajax comet, long polling or the likes)

Referring now to FIG. 4, there is shown a flow chart describing the ‘open document’ 10 process in details, which initiates by FIG. 2 element 140.

Referring again to FIG. 4, ‘open document’ 10, the document, now in HTML format, is being displayed on GUI as well as the tree which was mentioned at FIG. 2 ‘show screen’ 30. At this point the system does ‘wait for input’ 50 and the user can choose to do one of several actions as follows;

Still referring to FIG. 4, ‘Mark a portion of the document’ 30 is the act of marking a portion of the document as in preparation for ‘copy to clipboard’ common in text editors. The marking can be done using Mouse Dragging or using SHIFT+UP/DOWN. After that the flow returns to ‘wait for input’ 50

Still referring to FIG. 4, if a marking has been performed, ‘Associate a previously marked portion to a node’ 100 may be performed by the user. This is done by dragging the marked portion from the document at the main pane (FIG. 7 element 20) and dropping it onto a node in the tree pane (FIG. 7 element 10). This association is referred to as a ‘tag’ in the context of this invention.

Still referring to FIG. 4, and element 100, before saving, the server checks if the user has a sufficient ‘authority’ (authority calculation explained later) on this node for committing this action. If yes—the action is committed and registered in the history log; if no—an error is displayed to the user. After that, the flow returns to ‘wait for input’ 50.

Still referring to FIG. 4, the user is also given common functions to read the document such as ‘scroll throughout the document text’ 110 by the means of a scroll bar, and to ‘find text’ 70 in the document. After that the flow returns to ‘wait for input’ 50

Still referring to FIG. 4, the user may choose to ‘exit document view’ 120—which clears the document from the view, and flow returns to FIG. 2 element 70.

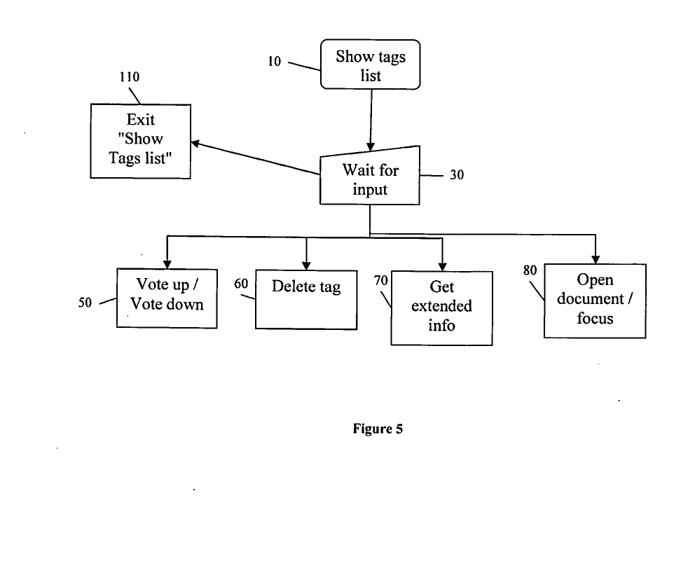

Referring now to FIG. 5, there is shown a flowchart of the ‘show tags list’ 10 process, which initiates by FIG. 8, element 90. The system displays the list of tags associated with the selected tree node. This view is opened at the main pane (FIG. 7 element 20). If a document has been previously opened, on the main pane, it comes in its place. The shown details for each tag comprising: tag score, original file name, name of user who tagged, date/time of tagging, first 100 characters of tagged text.

Still referring to FIG. 5 and ‘show tags list’ 10, the list is sorted such that tags with higher score are shown first. Since the list might be large, the list is delivered from server in chunks, i.e. 50 entries at a time with a paging option [i.e. “Prev” 1, 2, 3 . . . 20 “Next”]

Still referring to FIG. 5, in addition, for each tags there are buttons to commit the following actions: ‘vote up’, ‘vote down’ 50; ‘delete tag’ 60, ‘Get extended info’ 70, ‘open document/focus’ 80.

Referring now to FIG. 5 in more details, after ‘show tags list’ 10 has finished drawing, the system goes into ‘wait for input’ 30 state, in which further user actions are possible, as illustrated.

Still referring to FIG. 5, the user may ‘vote up/vote down’ 50 on a tag, unless it's their own tag. The server is updated with the voting, and flow returns to ‘wait for input’ 30.

Still referring to FIG. 5, the user may request to ‘delete tag’ 60. The server checks if the user has a sufficient ‘authority’ (authority calculation explained later) on this node for committing this action. If yes—the action is committed and registered in ‘history log’. If no—the user receives a response that they are not permitted in carrying out this action. After, flow returns to ‘wait for input’ 30.

Still referring to FIG. 5, the user may request to ‘get extended info’ 70, in which case more information about the tag appears, comprising: how many users have clicked on ‘open document/focus’ 80 regarding this tag, and flow returns to ‘wait for input’ 30.

Still referring to FIG. 5, the user may request to ‘open document/focus’ 80, in which case the document is shown, similar to FIG. 4 element 10 (the implementation can use the same function), however in this context the associated tagged text is highlighted, and the scroll bars are adjusted such that the tagged text is viewable.

Still referring to FIG. 5, the user may choose to ‘exit show tags list’ 110—which clears the tags list on main pane, and flow returns to FIG. 2 element 70.

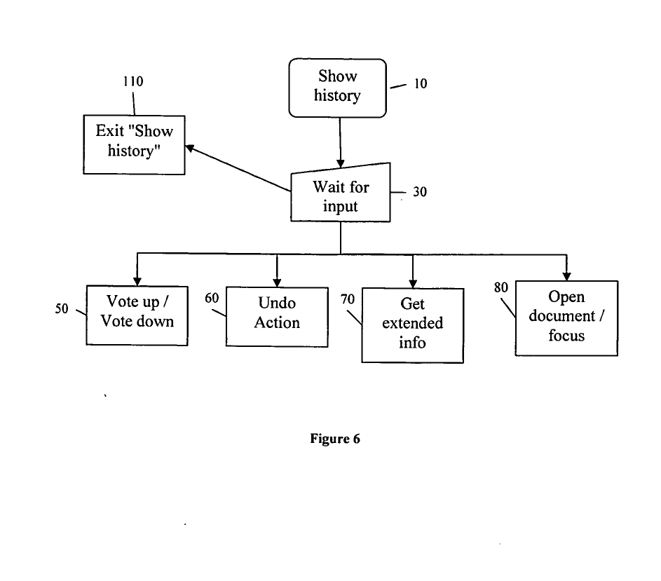

Referring now to FIG. 6, there is shown a flowchart of the ‘show history’ 10 process, which initiates by FIG. 8, element 100. The system displays the list of all history actions associated with the selected tree node. The view goes on the main pane (FIG. 7 element 20, instead of the document). The shown details for each row comprising: node name, action class, name of user who committed the action, date/time of action, a flag indicating whether the action was undone.

Still referring to FIG. 6 and ‘show history’ 10, in the GUI, further details on each row are shown as well, depending of the action class, allowing users to see additional information about the action:

‘create tag’, ‘delete tag’, ‘rename tag’, ‘move tag’: document name, tag text (first 100 characters);
‘move node’, ‘move tag’: source node, destination node;
‘rename node’: old node name.

Still referring to FIG. 6 and ‘show history’ 10, the list is sorted such that actions with a recent date are shown first. Since the list might be large, the list is delivered from server in chunks, i.e. 50 entries at a time with a paging option [i.e. “Prev” 1, 2, 3 . . . 20 “Next”]

Still referring to FIG. 6 and ‘show history’ 10, in the GUI, action buttons for each row are shown: ‘vote up’, ‘vote down’, ‘undo’.

Still referring to FIG. 6 and ‘show history’ 10, after the history list is shown, the system goes to ‘wait for input’ 30 from the user.

Still referring to FIG. 6, the users are able to perform ‘vote up/vote down’ 50 on a history row, in which case their vote is stored. After that, the flow goes back to ‘wait for input’ 30.

Still referring to FIG. 6, and ‘vote up/vote down’ 50: A vote on a history row is the same as voting directly on the action (for example, on a creation of a node the users can either vote from context-menu on the tree itself as in FIG. 8 element 80, or on the corresponding history record; and that vote would count only once). However, one advantage here is that it is possible and intuitive, using voting on history, to express opinion on delete actions (delete node, delete tag), no longer viewable elsewhere.

Still referring to FIG. 6, there exist ‘Undo action’ 60. An action can be undone by pressing on ‘undo’ button of the corresponding row. An action can be undone only where applicable. It is not applicable when: another user has already undone the action (in the meanwhile), or newer actions block the undo possibility (For example: trying to restore a tag whose container node has been deleted.) In such case, the user is presented with an error message explaining the error. After this, the flow returns to ‘wait for input’ 30

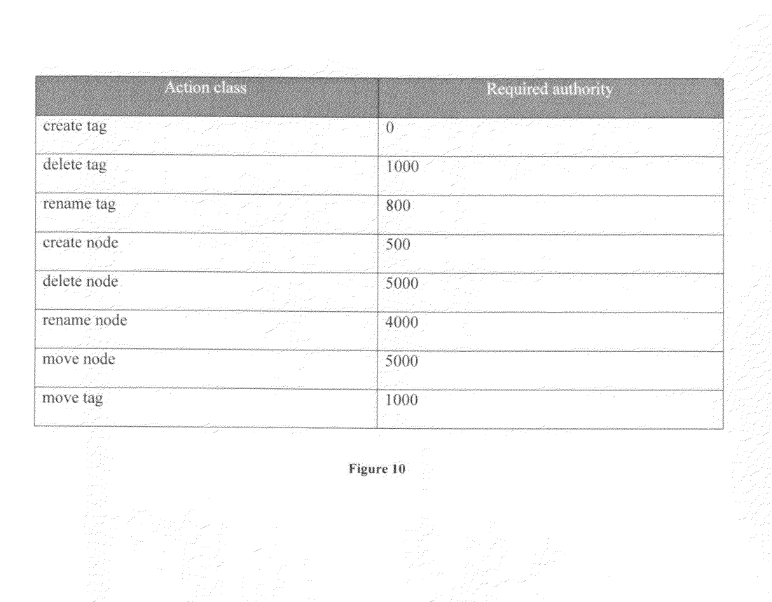

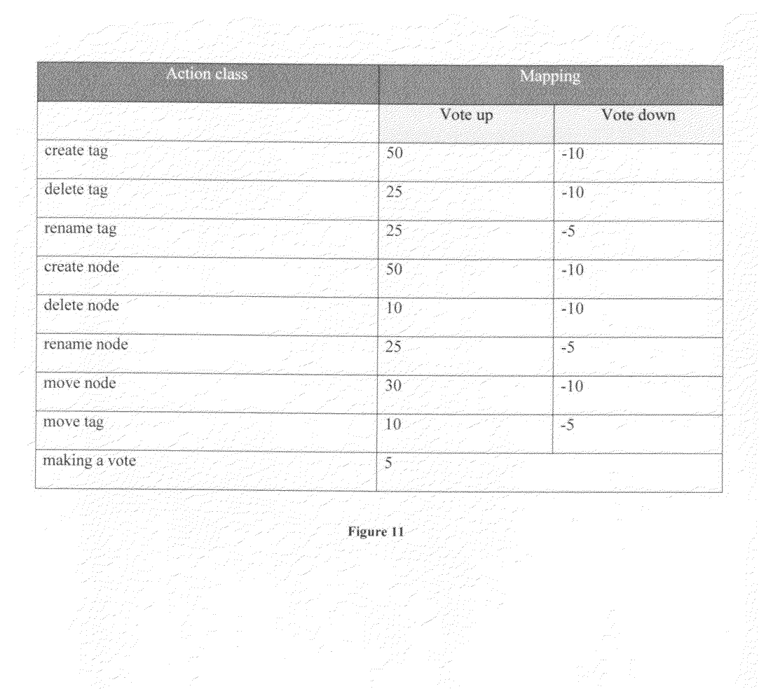

Still referring to FIG. 6, and ‘Undo action’ 60, before committing the UNDO, the system checks whether the user has sufficient ‘authority’ to perform the action (FIG. 10). The required permission is determined according to the new action, not the old one. For example, if the action which the user wishes to undo is ‘create node’, the required permission is for deleting a node in the respective location.

Still referring to FIG. 6, and ‘Undo action’ 60, the new action which is a result of the undo action is registered as a new action in the history log, and could be undone in the future, as well. However, once a particular action has been undone successfully, it cannot be undone again.

Still referring to FIG. 6, there exist ‘Get extended info’ 70. This brings a dialog which shows additional information on the row, comprising the full text of the tag, if this action is a tag-related action, such as ‘create tag’, ‘delete tag’, ‘rename tag’. After this, the flow returns to ‘wait for input’ 30

Still referring to FIG. 6, the user may request to ‘open document/focus’ 80, which is only relevant to history rows related to tags: ‘create tag’, ‘delete tag’, ‘move tag’. The document is shown, similar to FIG. 4 element 10 (the implementation can use the same function), however in this context the associated tagged text is highlighted, and the scroll bars are adjusted such that the tagged text is viewable. The document text goes to the main pane (FIG. 7 element 20), in place of history list currently shown.

Still referring to FIG. 6, the user may request to ‘exit show history’ 110 in which case the main pane (FIG. 7 element 20) is cleared, and flow returns to FIG. 2 element 70.

Referring now to FIG. 8, there is shown a flowchart of the ‘manage the tree’ 10 process, which initiates by FIG. 2, element 150. The system provides a taxonomy tree (shown in FIG. 2, element 30) as an important component for allowing the users to retrieve and organize information. Some of the tree management actions are performed using ‘right-click context menu’ on a node; some as tooltip when hovering over a node; some using drag & drop; some as a click.

Still referring to FIG. 8, from the context menu the user can ‘add node’ 30, after which they are asked to enter the new node name (in a dialog box) and if they have the appropriate authority to create a node at this location, it is created and the action is registered in the history log; otherwise, an error is displayed. After this, the flow returns to FIG. 2, element 70.

Still referring to FIG. 8, using ‘drag & drop’ the user can ‘move node’ 40, from one location to another and if they have the appropriate authority, it is moved and the action is registered in the history log; otherwise, an error is displayed. After this, the flow returns to FIG. 2, element 70.

Still referring to FIG. 8, from the context menu the user can ‘delete node’ 50. if they have the appropriate authority, it is deleted and the action is registered in the history log; otherwise, an error is displayed. After this, the flow returns to FIG. 2, element 70.

Still referring to FIG. 8, from the context menu the user can ‘rename node’ 70; they are asked to enter the new node name (in a dialog box) and if they have the appropriate authority to rename a node at this location, it is renamed and the action is registered in the history log; otherwise, an error is displayed. After this, the flow returns to FIG. 2, element 70.

Still referring to FIG. 8, from the context menu the user can ‘vote on a node’ 80, that is, vote up or vote down on the very action of the creation of that node. After the user votes, the information is saved by the server. No special permission is required here. After this, the flow returns to FIG. 2, element 70.

Still referring to FIG. 8, after clicking on a node, function ‘show tags list’ 90 is called, further explained in FIG. 5.

Still referring to FIG. 8, from the context menu the user can ‘show history’ 100. This function is further explained in FIG. 6.

Still referring to FIG. 8, when hovering over a node, the system does ‘show information’ 110 about the node. The information is: creation time/date of the node, the amount of authority the user has on the node, top 3 users (who has the most authority) on the node. After this, the flow returns to FIG. 2, element 70.

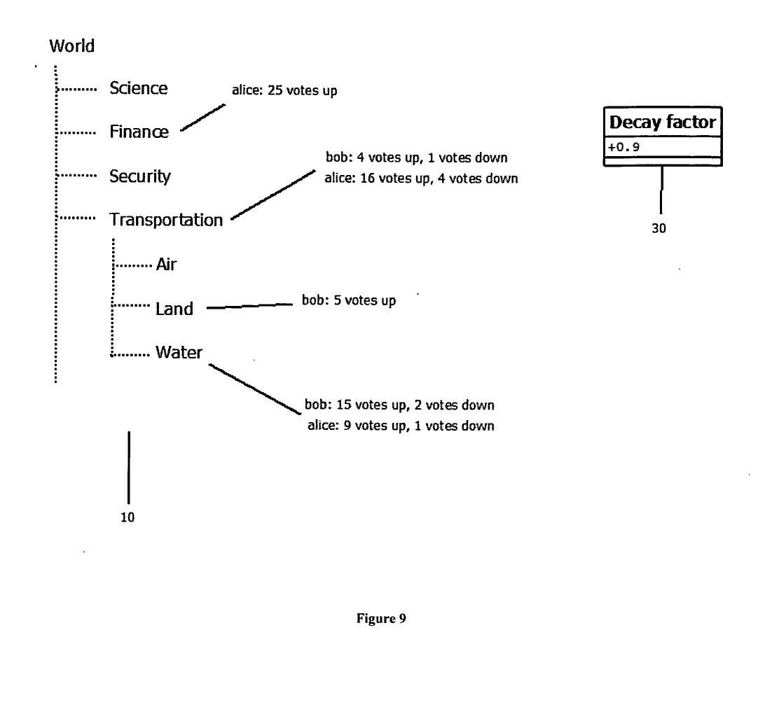

Referring now to FIG. 9, there is shown an illustration of a tree 10 with voting values assigned to various nodes and two fictitious users, ‘Bob’ and ‘Alice’, and a ‘decay factor’ 30 parameter with its value assigned as 0.9. Referring now to FIG. 11 there is shown the ‘voting score mapping’ data structure. It is now elaborated how authority score is calculated in the system on the basis of user actions and ‘voting score mapping’ in FIG. 11.

The function for calculating authority score of a node is:

let N be a node in the system, and let U be a user in the system. Authority (N,U)=local authority score (N,U)+(the sum of all authority scores of N's children)*Decay factor.
Note: this function is recursive.

Referring to FIG. 9, the discussion is around two users: Bob and Alice. It is assumed that Bob and Alice are the only users who performed tagging in the system. It is assumed that various other users have voted on Bob and Alice' tags. It is also assumed that Bob and Alice' only actions were tagging, they did not add new tree nodes etc.

Still referring to FIG. 9, to calculate Bob's authority score for node ‘Water’, the system sees that Bob received 15 votes up, and 2 votes down. The system now look at ‘voting score mapping’ (FIG. 11) and finds that getting a vote up on creating a tag worth 50, whilst getting a vote down worth −10. The result formula is: 15*50+2*−10=730 and this is Bob's authority score for node ‘Water’.

Still referring to FIG. 9, to calculate Alice's authority score for node ‘Water’, The system applies the same logic: The result formula is: 9*50+1*−10=440 and this is Alice's authority score for node ‘Water’.

Still referring to FIG. 9, to calculate Bob's authority score for sibling node ‘Land’, The system applies the same logic: The result formula is: 5*50=250 and this is Bob's authority score for node ‘Land’.

Still referring to FIG. 9, it would now be further explained how to calculate authority in nodes that have children, such as ‘Transportation’ and ‘World’. To calculate Bob's local authority for node ‘Transportation’ first system sees that Bob received 4 votes up and 1 vote down. The system now looks at ‘voting score mapping’ and finds that getting a vote up on creating a tag worth 50, whilst getting a vote down worth −10. The result formula is: 4*50+1*−10=190 and this is Bob's local authority score for node ‘Transportation’.

Still referring to FIG. 9, to calculate Alice's local authority for node ‘Transportation’ first system sees that Alice received 16 votes up, and 4 vote down. The system now looks at ‘voting score mapping’ (FIG. 11) and finds that getting a vote up on creating a tag worth 50, whilst getting a vote down worth −10. The result formula is: 16*50+4*−10=760 and this is Alice's local authority score for node ‘Transportation’.

Still referring to FIG. 9, to get Bob and Alice' authority score on ‘Transportation’, as opposed to local authority score which was already shown, one needs to add the authority of all the children of ‘Transportation’ multiplied by ‘decay factor’ (0.9 in this embodiment) to the local authority score. Thus, Bob's authority score on ‘Transportation’ is: 190+(250+730)*0.9=1072. Alice's authority score on ‘Transportation’ is: 760+(440)*0.9=1156

Still referring to FIG. 9, Bob and Alice' authority score on ‘Finance’: Bob has 0, Alice has 25*50=1250

Still referring to FIG. 9, in order to get Bob and Alice' authority score on ‘World’ the full calculation is:

Authority(Alice,World)=0.9[1250+760+0.9(440)]=2165.4

Authority(Bob,World)=0.9[190+0.9(250+730)]=964.8

Referring now to FIG. 10, there is shown a data structure which maps each action to a required authority for a user (with regards to a parent node) to perform it. It is shown that anyone can create a tag (0 authority required). To delete or rename a tag one needs to have 1000 or 800 authority on the container node, respectively. To create, delete, rename a node one needs to have 500, 5000 or 4000 authority on the container node, respectively. To move a node or move a tag one needs to have 5000 or 1000 authority, respectively, on both source and destination container nodes.

Referring to FIG. 9 and FIG. 10, from the calculation it is concluded that Alice may, if she chooses to, delete tags associated with node ‘World’, since she has authority score of 2165.4, which is >1000; and that Bob cannot delete tags associated with node ‘World’ since he has only 964.8, which is <1000.

In all occurrences in the system in which the user can vote, a user can't vote on actions done by him or her. A user may vote only once on each action, but they can change their vote from up to down and vice versa.

The advantages of the present invention include, without limitation, the building of taxonomy in a collaborative manner, the ability to associate document portions to nodes, a voting system that allows voting on history action and on tree nodes actions, a format conversion module that converts documents into a unified format allowing more responsive and quick user experience.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. System and method for collaborative structuring of portions of entities over computer network comprising:
uploading data content to a data base (11) in said system (FIG. 1);
accessing said uploaded data content;
tagging a portion of said uploaded data content; and
associating said tagged portion to at least one node on at least one taxonomy tree.

2. A method according to claim 1 wherein said at least one node is created or modified by a user.

3. A method according to claim 2 further comprising authorizing said user to create or modify at least one node.

4. A method according to claim 3 wherein said authorizing is by a ranking process.

5. A method according to claim 4 wherein said ranking value is determined by voting.

6. A method according to claim 5 wherein said ranking process assigns a ranking value to said at least one node.

7. A method according to claim 6 comprising sending a digital message to said copyright holder.

8. A method according to claim 1 comprising saving a history of said at least one node.

9. A method according to claim 8 comprising recovering at least one erased tag from said saved history.

10. A method according to claim 1 comprising purchasing proprietary data content based on said displayed tagged portion.

11. A method according to claim 1 comprising displaying votes associated with said tagged portion.

12. A server-based system (FIG. 1) for collaborative structuring of portions of entities over computer network comprising:
a data storage (11);
a server (9);
at least one user client device (1,2,3); and
at least one module including software for allowing a user to tag at least a portion of data content uploaded to said data storage (11) and to associate said tagged portion with at least one node in a taxonomy tree associated with a search engine.

13. A server-based system (FIG. 1) according to claim 12 wherein said at least one module includes software for creating or modifying at said least one node in said taxonomy tree.

14. A server-based system (FIG. 1) according to claim 12 wherein said at least one module includes software for allowing said user to vote on said tagged portion.

15. A module comprising:
software for allowing a user to tag at least a portion of data content uploaded to a data storage (11) in server-based system (9) and to associate said tagged portion with at least one node in a taxonomy tree associated; and
software for creating or modifying at least one node in a taxonomy tree associated with said tagged portion.

16. A module according to claim 15 further comprising software for allowing said user to vote on said tagged portion.

17. A module according to claim 15 further comprising software for allowing a user to register and login to a server-based system (FIG. 1).

18. A module according to claim 15 further comprising software for allowing a user purchase proprietary content data based on information contained in said tagged portion.

19. A method according to claim 1 wherein said taxonomy is shown as a list of topics in which it is possible to go one tree-level up or down.

20. A module according to claim 15 wherein said taxonomy is shown as a list of topics in which it is possible to go one tree-level up or down.
